(19) United States
(12) Patent Application Publication
(10) Pub. No.: US 2024/0272609 A1
(43) Pub. Date: Aug. 15, 2024

(54) SCREEN CREATION DEVICE, SCREEN CREATION SYSTEM, AND COMPUTER-READABLE RECORDING MEDIUM

(71) Applicant: Fanuc Corporation, Minamitsuru-gun, Yamanashi (JP)

(72) Inventors: Shinichi Ozeki, Minamitsuru-gun, Yamanashi (JP); Kouji Osada, Minamitsuru-gun, Yamanashi (JP)

(73) Assignee: Fanuc Corporation, Minamitsuru-gun, Yamanashi (JP)

(21) Appl. No.: 18/568,361

(22) PCT Filed: Jun. 22, 2021
(86) PCT No.: PCT/JP2021/023640

§ 371 Date: Dec. 8, 2023

(51) Int. Cl. G05B 19/4093; G05B 19/409; G05B 19/4155

(52) U.S. Cl. CPC G05B 19/4093; G05B 19/409; G05B 19/4155

(57) ABSTRACT

A screen creation device, which supports the creation of a user interface screen of a numerical control device, stores, in a component library, components disposed on the user interface screen and a composite component obtained by combining a plurality of components, stores an execution function name that can be used to operate the composite component, reads the execution function name that can be used to operate the composite component, presents the execution function name to a user, and accepts the setting of the presented execution function as a component.

### CROSS REFERENCE TO RELATED APPLICATIONS

This is the U.S. National Phase application of PCT/JP2021/023640, filed Jun. 22, 2021, the disclosure of this application being incorporated herein by reference in its entirety for all purposes.

### FIELD OF THE INVENTION

The present invention relates to a screen creation device, a screen creation system, and a computer-readable storage medium.

### BACKGROUND OF THE INVENTION

A numerical controller is a machine that controls a machine tool. The numerical controller is provided with a user interface screen (referred to as a UI screen). The UI screen displays a state of the machine tool and receives input of an operator.

Examples of a control target of the numerical controller include a lathe, a drilling machine, a boring machine, a milling machine, a grinding machine, a machining center, a turning center, and an electric discharge machine. A developer of the UI screen creates the UI screen according to a type of machine tool, a machine configuration of the machine tool, and specifications required by a user.

For example, FIG. 3 of Patent Document 1 is an example of a display screen of a spindle load. This screen displays a state of a machine tool “automatic driving”, a current time “2002/4/23 21:53:40”, a graph of the spindle load, a program being executed, and screen operation buttons.

Conventionally, there has been dedicated software for creating a UI screen for a numerical controller. This software provides parts for screen creation. The developer of the UI screen arranges these parts on the UI screen, sets properties (attributes and execution functions) of the individual parts, and completes the UI screen.

### PATENT DOCUMENT

Patent Document 1: JP 2004-126956 A

### SUMMARY OF THE INVENTION

There are a huge number of types of execution functions to be set for each part of the UI screen. FIG. 16 is a diagram illustrating a list of conventional execution functions. It is troublesome for a UI screen developer to select an appropriate execution function from a huge number of options.

Techniques for simplifying creation of user interfaces are desirable in the field of numerical controllers.

A screen creation device which is an aspect of the disclosure is a screen creation device for supporting creation of a user interface screen of a numerical controller, the screen creation device including a part library configured to store a part arranged on the user interface screen and a composite part obtained by combining a plurality of parts, an available function storage unit configured to store an available execution function name for an operation of the composite part, and an editing unit configured to read an available execution function name for an operation of the composite part, present the execution function name to a user, and receive setting of the presented execution function to the part with reference to the available function storage unit.

A storage medium which is an aspect of the disclosure is a storage medium storing a computer-readable instruction, the storage medium being configured to store a part arranged on a user interface screen of a numerical controller and a composite part obtained by combining a plurality of parts, and store an available execution function name for an operation of the composite part, wherein the storage medium reads an available execution function name for the composite part, presents the execution function name to a user, and receives setting of the presented execution function to the part by execution of one or a plurality of processors. A screen creation system which is an aspect of the disclosure is a screen creation system for supporting creation of a user interface screen of a numerical controller, the screen creation system including a part library configured to store a part arranged on the user interface screen and a composite part obtained by combining a plurality of parts, an available function storage unit configured to store an available execution function name for an operation of the composite part, and an editing unit configured to read an available execution function name for an operation of the composite part, present the execution function name to a user, and receive setting of the presented execution function to the part with reference to the available function storage unit.

According to one aspect of the invention, it is possible to simplify creation of a user interface.

### BRIEF DESCRIPTION OF DRAWINGS

FIG. 1 is a diagram illustrating a relationship between a screen creation device and a numerical controller;

FIG. 2 is a block diagram of a screen creation device of a first disclosure;

FIG. 3 is an example of a UI editing screen;

FIG. 4 is a diagram illustrating a relationship between a composite part and a single part;

FIG. 5 is a diagram illustrating a relationship between a composite part and a single part;

FIG. 6 is a diagram illustrating a relationship between a composite part and an operation (execution function);

FIG. 7 is a diagram illustrating a relationship between a composite part and an operation (execution function);

FIG. 8 is an example of an available function storage unit;

FIG. 9 is a diagram illustrating a list of execution functions;

FIG. 10 is a diagram for describing a template of a UI screen;

FIG. 11 is a block diagram of a screen creation device of a second disclosure;

FIG. 12 is a diagram illustrating a screen configuration of the UI screen;

FIG. 13 is an example of an available function storage unit of the second disclosure;

FIG. 14 is a block diagram of a screen creation device of a third disclosure;

FIG. 15 is a diagram for describing a hardware configuration of the screen creation device; and

FIG. 16 is a diagram illustrating a list of conventional execution functions.

### FIRST DISCLOSURE

A screen creation device 100 of a first disclosure will be described below.

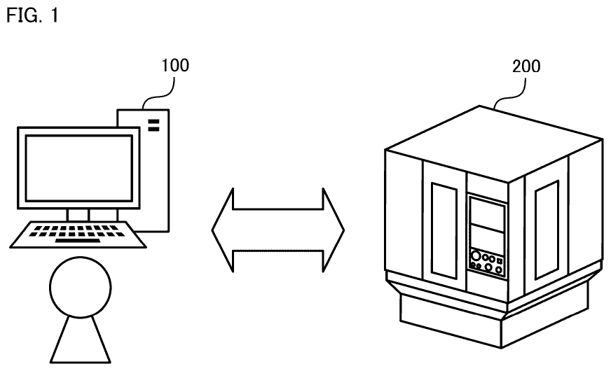

For example, as illustrated in FIG. 1, the screen creation device 100 is installed in an information processing device such as a PC (personal computer). Dedicated software for creating an operation screen of the numerical controller 200 is installed in the screen creation device 100. A user operates software to create a UI screen. The UI screen created by dedicated software is transferred to the numerical controller 200 and displayed on a display unit of the numerical controller 200.

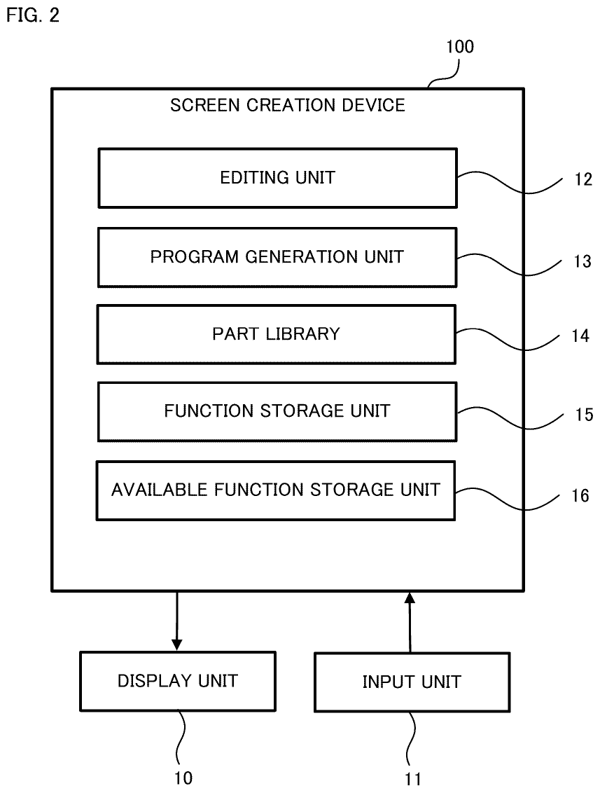

FIG. 2 is a block diagram of the screen creation device 100. The screen creation device 100 includes a display unit 10, an input unit 11, an editing unit 12, a program generation unit 13, a part library 14, a function storage unit 15, and an available function storage unit 16.

The editing unit 12 displays a UI editing screen 20 on the display unit 10 of the screen creation device 100 and receives an editing operation by the user. The editing unit 12 updates screen layout and properties (attributes) of parts according to input of the user.

The program generation unit 13 converts the properties of the parts and layout of the UI screen created by the editing unit 12 into an executable program. The executable program is implemented in the numerical controller 200 and function as the UI screen.

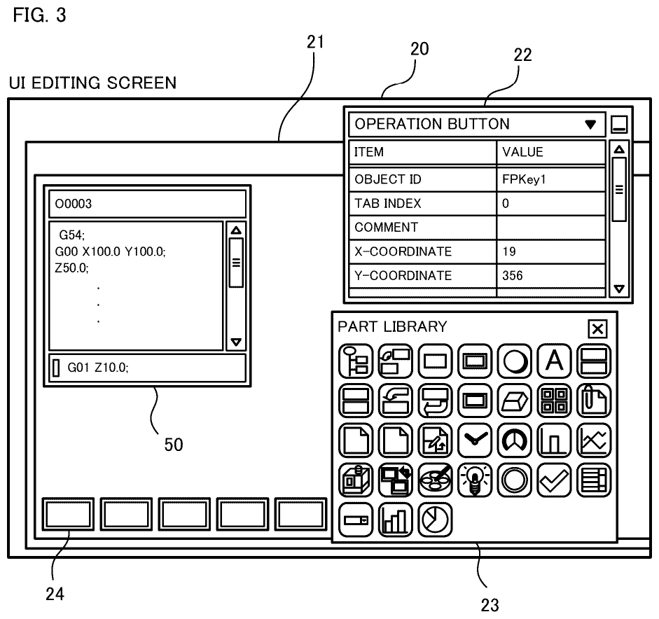

FIG. 3 is an example of the UI editing screen 20. The UI editing screen 20 of FIG. 3 includes a UI editing region 21, a property display region 22, and a part library display region 23. A part to be arranged on the UI screen can be selected from the part library display region 23. Five parts (operation buttons 24) are arranged on the UI editing screen. One of the five operation buttons 24 is in a selected state. A property of the selected operation button 24 is displayed in the property display region 22.

In the property display region 22, information related to a part such as visual information such as a size, a shape, or coordinates of the part, a label such as a numerical value, an icon, or a character string, a type of part, a name of the part, and an operation (execution function) of the part can be set.

The function storage unit 15 stores an execution function. A relationship between the operation button 24 and the execution function will be described later.

The part library 14 stores a part on the UI screen. The Part includes a single part and a composite part 50. The single part is an exclusive part. The single part includes the operation button 24, a key input button, a label, etc. However, the invention is not limited thereto.

The composite part is a part obtained by combining a plurality of single parts.

The composite part includes single parts.

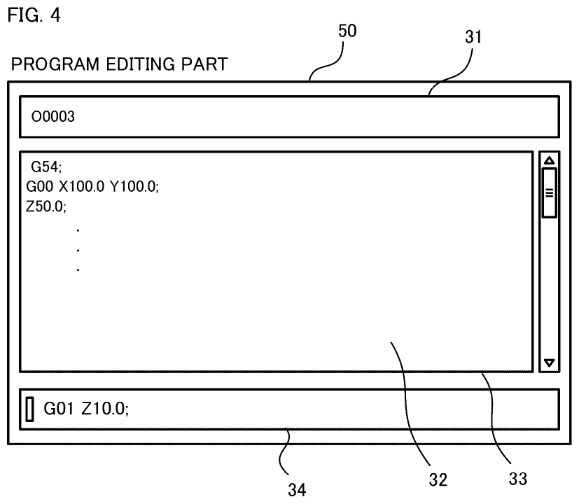

For example, the composite part 50 (program editing part) of FIG. 4 includes a plurality of single parts (a label display part 31, a figure display part 32, a multi-line character string display part 33, and an input reception part 34). The label display part 31 is a part that displays a character string. Here, a program name “00003” is displayed. The figure display part 32 is a part used for screen design. Here, a background is blue. The multi-line character string display part 33 is a part that displays a plurality of character strings. Here, a machining program is displayed in the multi-line character string display part 33. The input reception part 34 receives input of a character string to be edited. By pressing an “Enter” key, a character string input to the input reception part 34 is reflected in the multi-line character string display part 33.

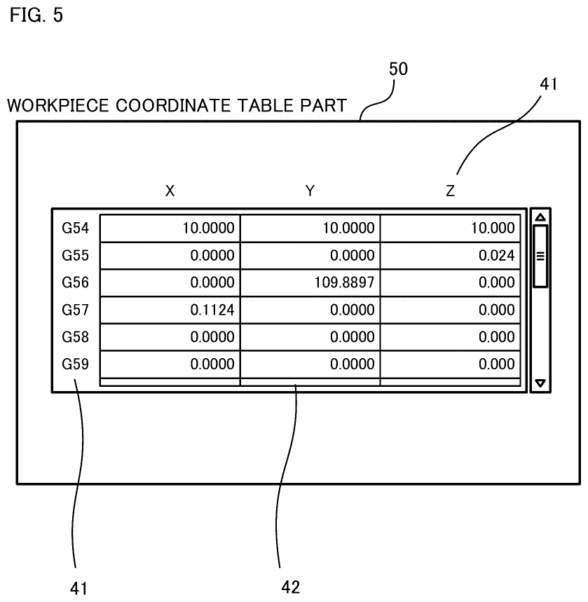

A composite part 50 (workpiece coordinate table part) of FIG. 5 includes a plurality of single parts (a label display part 41 and a table display part 42). Names of a workpiece coordinate system from “G54” to “G59” and axis names (“X-axis”, “Y-axis” and “Z-axis”) are displayed in the label display part 41.

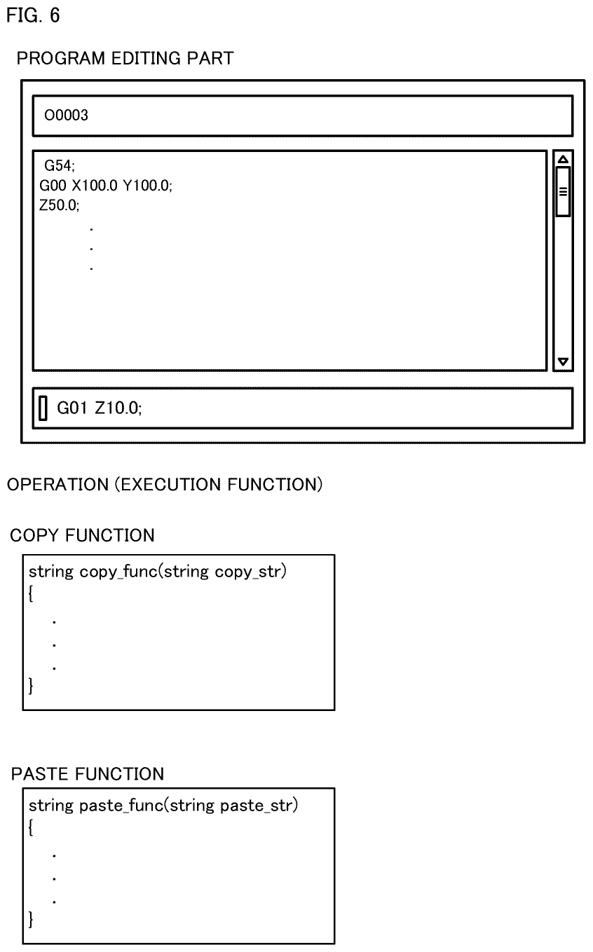

The composite part 50 is not merely a part, and has a meaning according to the purpose of use. Therefore, an operation (execution function) which is available in each composite part 50 is limited. For example, among execution functions for operating the program editing part, there are a copy function and a paste function (see FIG. 6). The copy function is a function for copying N lines of a machining program displayed in the multi-line character string display part to a clipboard, and the paste function is a function for pasting a character string copied to the clipboard to the multi-line character string display part. A function other than the copy function and the paste function can be used to operate the program editing part.

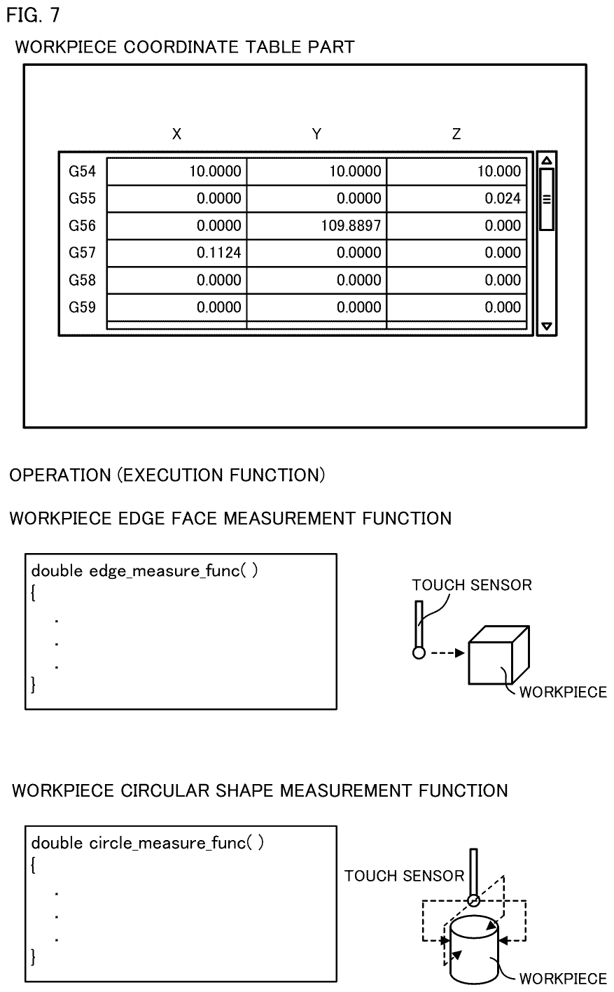

Among execution functions for operating the workpiece coordinate table part, there are a workpiece edge face measurement function and a workpiece circular shape measurement function (see FIG. 7). The workpiece edge face measurement function measures an edge face of a workpiece using a touch sensor, reads coordinates of a contact point, and displays a result thereof in a workpiece coordinate table. The workpiece circular shape measurement function measures several points of a circular workpiece using a touch sensor, reads center coordinates of a circle, and displays a result thereof in a workpiece coordinate table. The workpiece edge face measurement function and the workpiece circular shape measurement function can be used to operate the workpiece coordinate table part.

In the composite part, a function which is available according to the purpose of use is determined. The available function storage unit 16 is provided to store information on a function which is available in each composite part 50.

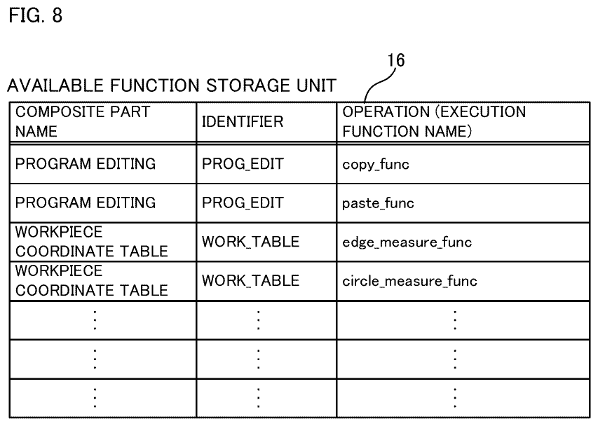

FIG. 8 is an example of the available function storage unit 16. The available function storage unit 16 associates “composite part name”, “composite part identifier”, and “operation (execution function name)” with each other. Referring to the available function storage unit 16 of FIG. 8, it can be seen that an identifier of a composite part name “program editing part” is “PROG_EDIT”, and operations (execution function names) “copy_func (copy function)”, “paste_func (paste function)”, etc. are available. It can be seen that an identifier of a composite part name “workpiece coordinate table” is “WORK_TABLE”, and operations (execution function names) “edge_measure func (workpiece edge face measurement function)”, “circle measure func (workpiece circular shape measurement function)”, etc. are available.

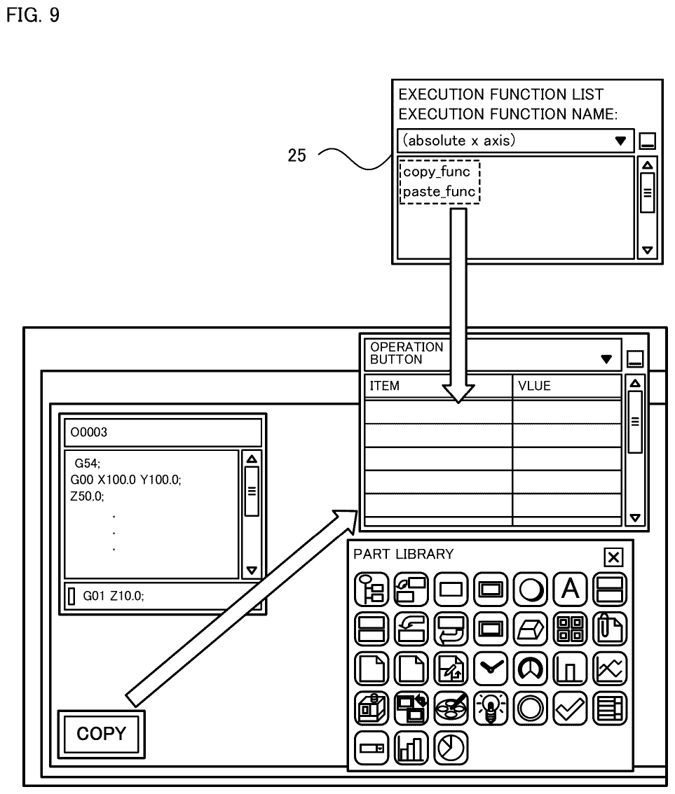

The editing unit 12 displays a list of available functions for operating the composite part 50 with reference to the available function storage unit 16. In an example of FIG. 9, an execution function list 25 is displayed for the composite part 50 (program editing part). Operations (execution function names) “copy_func”, “paste_func”, etc. are displayed in the execution function list 25 of FIG. 9. The user of the screen creation device 100 can create an operation button 24 for copying a machining program by attaching a label such as “copy” to the operation button 24 and setting “copy_func” as the operation (execution function name).

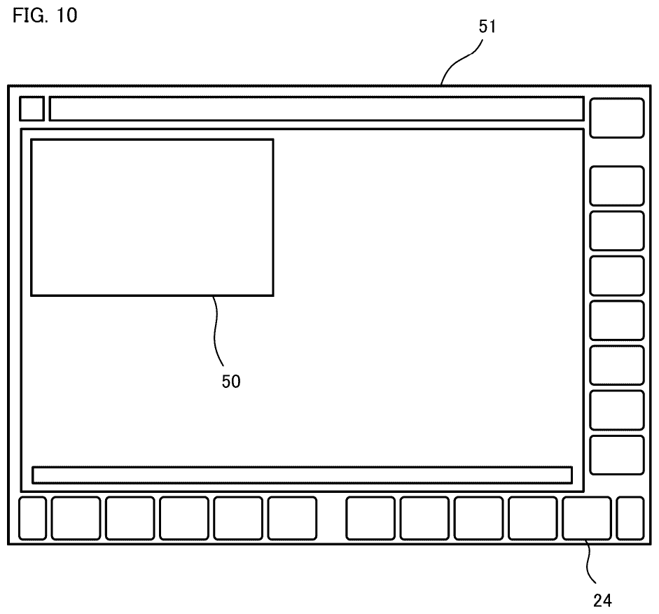

A template may be used to create an operation button 24. A UI creation region of FIG. 10 includes a base part 51 and a composite part 50. The base part 51 is a template. Operation buttons 24 for operating a UI screen are arranged in a region of a lower portion and a right portion of the base part 51. The composite part 50 or a single part can be arranged in a central region of the base part 51. When the template is used, there is no need to manually arrange single parts. When an operation button 24 prepared in advance is selected, and a necessary operation (execution function name) is selected from a list of operations (execution function names), a UI screen can be created.

In the screen creation device of the first disclosure, an operation (execution function name) which is available in each composite part 50 is stored, and the operation (execution function name) which is available in the composite part 50 is presented to the user. When only the available operation (execution function name) is displayed, searching for the operation (execution function name) is facilitated, and creation of the UI screen is facilitated.

### SECOND DISCLOSURE

Next, a screen creation device of a second disclosure will be described.

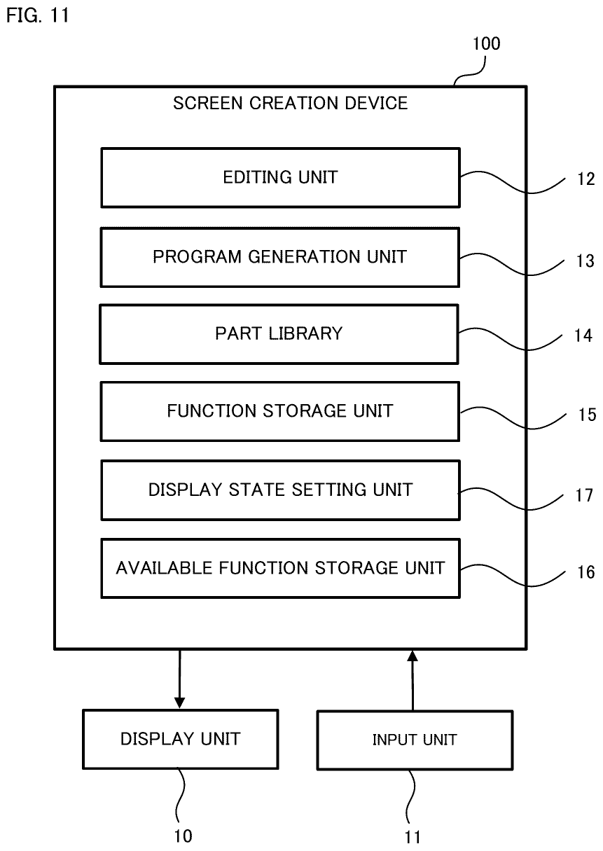

FIG. 11 is a block diagram of the screen creation device 100 of the second disclosure. The screen creation device 100 of the second disclosure includes a display unit 10, an input unit 11, an editing unit 12, a program generation unit 13, a part library 14, a function storage unit 15, an available function storage unit 16, and a display state setting unit 17. Only a difference from the screen creation device 100 of the first disclosure will be described below.

The screen creation device 100 of the second disclosure considers a display state of a UI screen and presents a function which is available in a composite part 50 to be operated.

The display state setting unit 17 receives setting of the display state by the user.

The display state of the UI screen includes a mode of the numerical controller 200, display/non-display of the composite part 50, selection/non-selection of the composite part 50, etc.

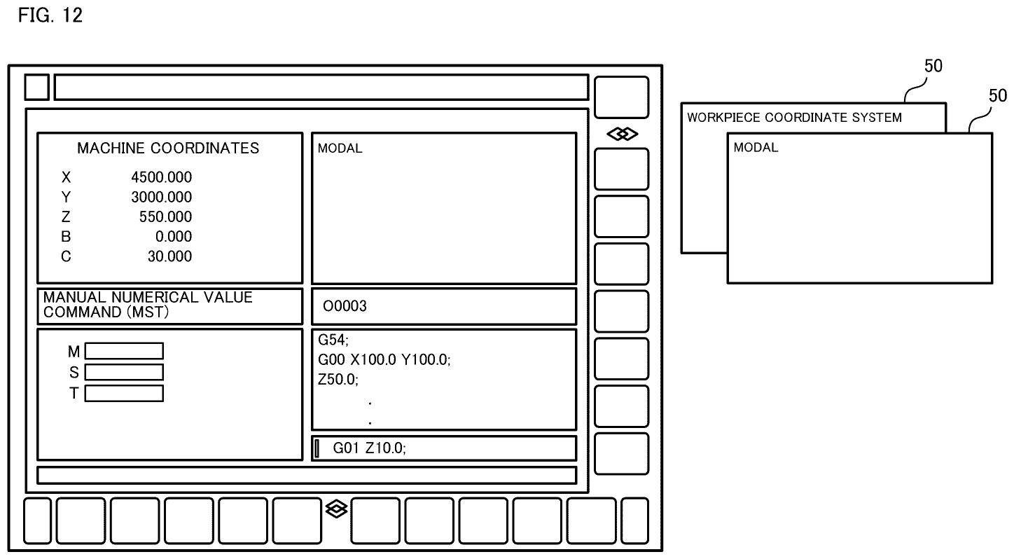

Display/non-display of the composite part 50 means whether or not the composite part 50 is displayed. For example, on the UI screen, as illustrated in FIG. 12, a plurality of composite parts 50 may be set in one display region. When one of the overlapping composite parts 50 is displayed, the other composite parts 50 are hidden. An operation (execution function) of the composite part 50 changes according to display/non-display of the composite part 50.

Examples of the mode of the numerical controller 200 include a mode related to a driving state of the numerical controller 200, a mode automatically generated according to a signal state of the numerical controller 200, etc. Examples of the mode related to the driving state of the numerical controller 200 include a mode related to the driving state of the numerical controller 200 such as a memory mode, an MDI mode, an editing mode, or a handle mode. Examples of the mode automatically generated according to the signal state of the numerical controller 200 include execution of an operation of workpiece coordinate measurement. Depending on the mode of the numerical controller 200, the operation (execution function) of the composite part 50 on the UI screen changes.

Selection/non-selection of the composite part 50 means a selection state of the composite part 50 on the UI screen. The operation (execution function) used on the UI screen changes depending on which composite part 50 is selected/unselected.

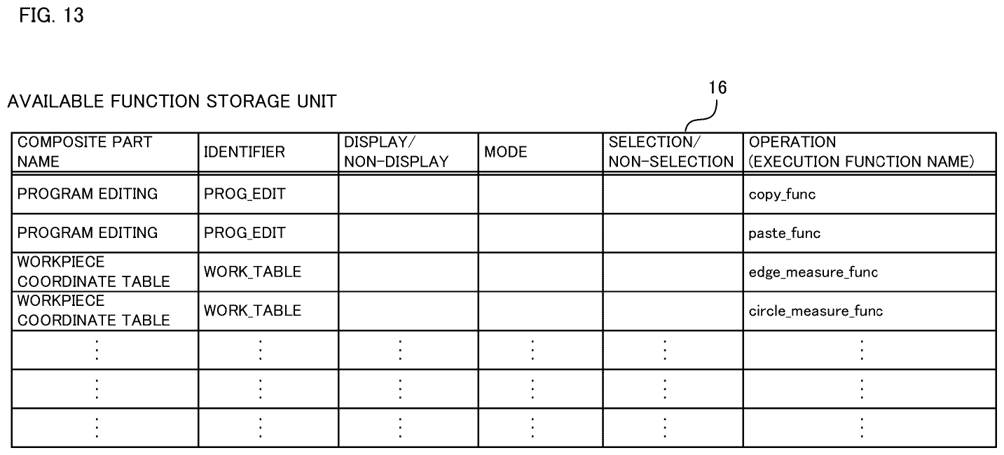

The available function storage unit 16 stores an operation (execution function name) which is available for each display state. FIG. 13 is an example of the available function storage unit 16 of the second disclosure. The available function storage unit 16 of the second disclosure associates “composite part name”, “identifier”, “display/non-display”, “mode”, “selection/non-selection”, and “operation (execution function name)” with each other.

The editing unit 12 reads, from the available function storage unit 16, an operation (execution function name) which is available by each composite part 50 for each display state set by the display state setting unit 17. The editing unit 12 presents, to the user, the operation (execution function name) which is available by each composite part 50 in each display state.

Note that, in the first disclosure and the second disclosure, only an available operation (execution function name) is displayed. However, an unavailable operation (execution function name) may be grayed out and displayed.

As described above, the screen creation device 100 disclosed in the second disclosure displays only an available operation (execution function name) for each display state, so that searching for the operation (execution function name) is facilitated, and creation of the UI screen is facilitated.

Note that a display state of the UI screen may be extracted from a program. The display state can be extracted from a program, etc. in which state transition of the screen is described.

Further, in the first disclosure and the second disclosure, the available function storage unit 16 is set to a table which associates the composite part 50 and the operation (execution function name) with each other. However, another data format may be used for storage. A format in which the available operation (execution function name) is stored in the composite part 50 may be adopted.

### THIRD DISCLOSURE

Next, a screen creation device 100 of a third disclosure will be described.

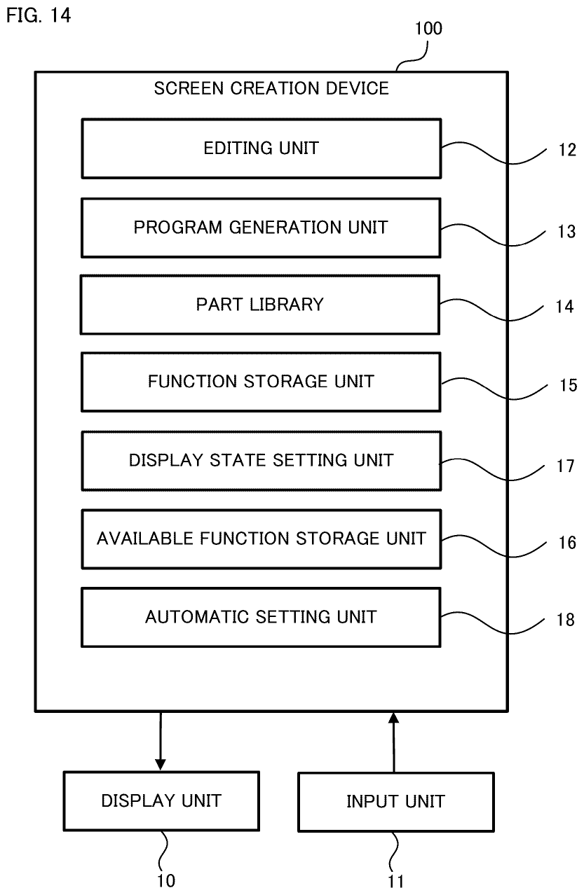

FIG. 14 is a block diagram of the screen creation device 100 of the third disclosure. The screen creation device 100 of the third disclosure includes a display unit 10, an input unit 11, an editing unit 12, a program generation unit 13, a part library 14, a function storage unit 15, an available function storage unit 16, a display state setting unit 17, and an automatic setting unit 18. Only a difference from the first disclosure and the second disclosure will be described below.

The available function storage unit 16 stores a required operation (execution function name) for each display state with respect to each composite part 50. The available function storage unit 16 of the third disclosure associates “composite part name”, “identifier”, “display/non-display”, “mode”, “selection/non-selection”, and “required operation (execution function name)” with each other.

The automatic setting unit 18 automatically sets the required operation (execution function) based on the display state of the composite part 50. Here, two methods are illustrated as a method of automatic setting. The method of automatic setting illustrated here is an example, and the invention is not limited thereto.

In a first method, the required operation (execution function) is set with reference to the available function storage unit 16. The available function storage unit 16 associates and stores the composite part 50, the display state, and the automatically set operation (execution function). For example, when the composite part 50 is “program editing”, the mode is “editing mode”, and selection/non-selection is “selection”, the automatic setting unit 18 automatically sets an execution function for performing operations of “copy” and “paste” of a machining program in the operation button 24 with reference to the available function storage unit 16.

In a second method, the operation (execution function) is automatically set based on a screen configuration of a UI screen. For example, as illustrated in FIG. 12, when a plurality of composite parts 50 is set in one display region, the automatic setting unit 18 automatically sets an operation button 24 for switching the composite part 50.

In the third disclosure, the required operation (execution function) is automatically set while considering the display state of the composite part 50. In this way, it is possible to reduce a burden on the user and prevent omission due to manual setting.

### [Hardware Configuration]

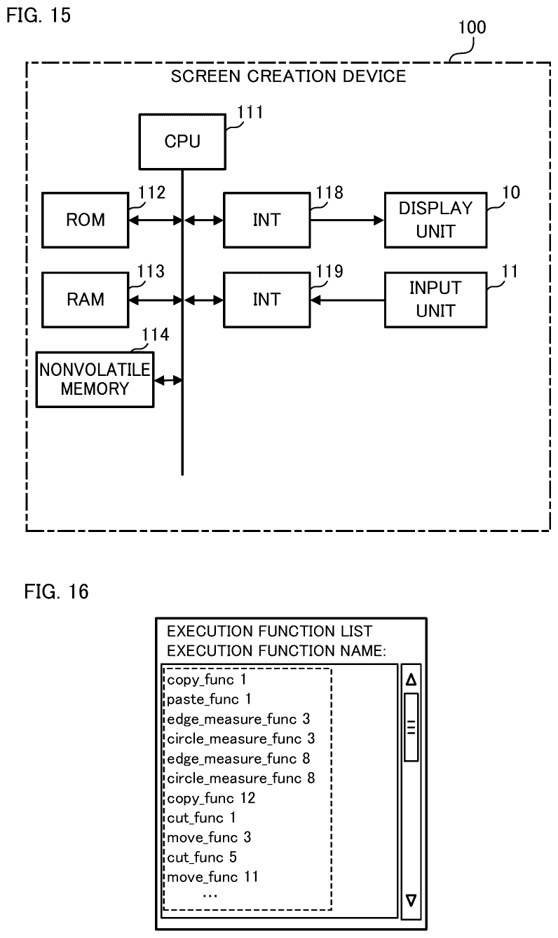

The screen creation device 100 in each of the first disclosure and the second disclosure has a hardware configuration illustrated in FIG. 15.

The hardware configuration of the screen creation device 100 will be described with reference to FIG. 15. A CPU 111 included in the screen creation device 100 is a processor that controls the entire screen creation device 100. The CPU 111 reads a system program processed in a ROM 112 via a bus and controls the entire screen creation device 100 according to the system program. Temporary calculation data or display data, various data input by the user via an input unit 11, etc. are temporarily stored in a RAM 113.

A display unit 10 is, for example, a monitor attached to the screen creation device 100. The display unit 10 displays the UI editing screen 20 of the screen creation device 100, etc.

The input unit 11 is integrated with the display unit 10 or is a keyboard, a touch panel, etc. separate from the display unit 10. The user operates the input unit 11 to create a UI screen.

A nonvolatile memory 114 is, for example, a memory that is backed up by a battery (not illustrated) so that a storage state is retained even when the power of the screen creation device 100 is turned off. A program read from an external device via an interface (not illustrated), a program input via the input unit 11, and various data acquired from each unit of the screen creation device 100, a machine tool, etc. (for example, a setting parameter acquired from the machine tool, etc.) are stored in the nonvolatile memory 114. The program and the various data stored in the nonvolatile memory 114 may be loaded in the RAM 113 during execution/use. In addition, various system programs are written to the ROM 112 in advance.

### EXPLANATIONS OF LETTERS OR NUMERALS

100 SCREEN CREATION DEVICE
10 DISPLAY UNIT
11 INPUT UNIT
12 EDITING UNIT
13 PROGRAM GENERATION UNIT
14 PART LIBRARY
15 FUNCTION STORAGE UNIT
16 AVAILABLE FUNCTION STORAGE UNIT
17 DISPLAY STATE SETTING UNIT
18 AUTOMATIC SETTING UNIT
20 UI EDITING SCREEN
25 EXECUTION FUNCTION LIST
111 CPU
112 ROM
113 RAM
114 NONVOLATILE MEMORY

1. A screen creation device for supporting creation of a user interface screen of a numerical controller, the screen creation device comprising:
a part library configured to store a part arranged on the user interface screen and a composite part obtained by combining a plurality of parts;
an available function storage unit configured to store an available execution function name for an operation of the composite part; and
an editing unit configured to read an available execution function name for an operation of the composite part, present the execution function name to a user, and receive setting of the presented execution function to the part with reference to the available function storage unit.

2. The screen creation device according to claim 1, further comprising a display state setting unit configured to receive setting of a display state of the composite part, wherein:
the available function storage unit stores an available execution function name for the composite part for each display state of the composite part; and
the editing unit presents the available execution function name for the composite part to the user, and receives setting of the presented execution function to the part in the set display state with reference to the available function storage unit.

3. The screen creation device according to claim 2, wherein the display state includes information of at least one of display or non-display of the composite part, selection or non-selection of the composite part, and a mode of the numerical controller.

4. The screen creation device according to claim 1, further comprising a display state setting unit configured to receive setting of a display state of the composite part, wherein:
the available function storage unit stores a required execution function name for the composite part for each display state of the composite part; and
the editing unit automatically sets a required execution function for an operation of the composite part to the part in the set display state with reference to the available function storage unit.

5. The screen creation device according to claim 1, further comprising a display state setting unit configured to receive setting of a display state of the composite part,
wherein the editing unit automatically sets a required execution function for an operation of the composite part to the part based on a screen configuration of the user interface screen and the display state.

6. A storage medium storing a computer-readable instruction, the storage medium being configured to:
store a part arranged on a user interface screen of a numerical controller and a composite part obtained by combining a plurality of parts; and
store an available execution function name for an operation of the composite part,
wherein the storage medium reads an available execution function name for the composite part, presents the execution function name to a user, and receives setting of the presented execution function to the part by execution of one or a plurality of processors.

7. A screen creation system for supporting creation of a user interface screen of a numerical controller, the screen creation system comprising:
a part library configured to store a part arranged on the user interface screen and a composite part obtained by combining a plurality of parts;
an available function storage unit configured to store an available execution function name for an operation of the composite part; and
an editing unit configured to read an available execution function name for an operation of the composite part, present the execution function name to a user, and receive setting of the presented execution function to the part with reference to the available function storage unit.
